(19) United States
(12) Patent Application Publication
(10) Pub. No.: US 2007/0039750 A1
(43) Pub. Date: Feb. 22, 2007

(54) Toll transponder case having functional attachments

(76) Inventor: John R. Jantelezio, Naperville, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 11/205,723

(22) Filed: Aug. 17, 2005

(51) Int. Cl. H02G 3/08

(52) U.S. Cl. 174/50

(57) ABSTRACT

A storage system incorporates a toll transponder mounted to the inside of a vehicle windshield. A transponder case surrounds the toll transponder whereby the transponder supports the case on the vehicle windshield. The case includes a hook and loop attachment for mounting functional items to the case such as a pocket, an eyeglasses case or a holder for other items.

### TECHNICAL FIELD OF THE INVENTION

The present invention relates to toll transponder cases.

### BACKGROUND OF THE INVENTION

Automatic toll collection using toll transponders mounted to a vehicle is becoming increasingly popular in the states of the United States that collect tolls for highway usage. The toll transponder or detector is mounted within the vehicle, typically on an inside surface of the windshield. Typically, the toll transponder or detector is removably attached to the windshield by strips of hook and loop fasteners such as VELCRO brand strips. Alternatively, suction cups or other attachments devices can be used. When hook and loop fasteners are used, two strips are secured to the inside surface of the windshield by adhesive and two engageable strips are attached by adhesive to the toll transponder. The strips are designed to be releasably engageable such as one pair of strips having loops and the opposite pair of strips having hooks.

U.S. Pat. No. 6,745,925 describes a case for enclosing a toll transponder. The advantages of providing a case to cover a toll transponder are set forth in this patent. The case allows the vehicle owner to retain the original appearance of the vehicle to cover an otherwise unsightly functional device on the windshield. The case can be made of a soft material to provide protection and cushioning when they transponder is removed from the vehicle, and provides a pleasing aesthetic appearance. The case can be decorated with imprints and designs to match the interior and/or exterior appearance of the vehicle. Logos, advertisements, emblems, decorations are like can be provided on the case. U.S. Pat. No. 6,745,925 is herein incorporated by reference.

The present inventor has recognized that it would be desirable if a toll transponder case provided additional functions. The present inventor has recognized that it would be desirable if a toll transponder case included an attachment function for holding useful items that would otherwise be loosely stored within a typical vehicle. The present inventor has recognized the desirability of providing a storage option for a toll transponder case for holding items which may be needed by the driver without requiring the driver to cast his eyes downward, and off the road, to find such items.

### SUMMARY OF THE INVENTION

The present invention provides a storage system incorporating the known method of attaching a toll transponder to a vehicle windshield. A toll transponder case surrounds a toll transponder that is securable to a windshield whereby the transponder supports the case. The case includes a means for mounting functional items to the case such as holders for items. The case provides an aesthetically appealing appearance to the otherwise functional-looking transponder, and the attachable functional items to the case can be coordinated in appearance with the case.

The invention provides a toll transponder case assembly that includes a transponder case for surrounding at least a portion of a toll transponder and a holder for holding items, wherein the transponder case and the holder are interengageable by the use of a releasable fastener.

The releasable fastener preferably comprises interengaging hook and loop strips applied between the case and the holder.

The holder can comprise an eyeglasses case. The eyeglasses case can include a closable opening on each opposite end of the eyeglasses case. The eyeglasses case can comprise a tubular body closed on opposite ends by an openable flap.

The holder can comprise a pocket. The pocket can be closed by at least one flap to secure items therein.

The releasable fastener can comprise engageable fastening strips, applied to both the transponder case and to the holder, wherein the fastening strip applied to the holder extends above the holder.

The releasable fastener can comprise a fastening strip applied onto a front side of the transponder case and a fastening strip applied onto a rear side of the holder wherein a back side or the holder is releasably fastened to a front side of the transponder case.

For both the eyeglasses case and the pocket, items can be conveniently stored at the elevated level of the transponder on the windshield. Thus, the driver can access these items without having to cast his eyes downward to find the items, for example for items otherwise located within the floor level or dash level vehicle console.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a schematic elevational view of an inside portion of a vehicle from the driver's perspective;

FIG. 2 is a rear perspective view of a transponder case, holding a toll transponder therein, according to the present invention;

FIG. 3 is a front perspective view of the transponder case shown in FIG. 2;

FIG. 4 is a front view of the trasponder case of FIG. 2 with transponder removed and in an open configuration;

FIG. 5 is a rear perspective view of an eyeglasses case to be used with the transponder case shown in FIG. 2;

FIG. 5A is a sectional view taken generally through line 5A-5A of FIG. 5;

FIG. 6 is a rear perspective view of a utility pocket to the used with the transponder case of FIG. 2; and

FIG. 7 is an alternate embodiment of the utility pocket shown in FIG. 6.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

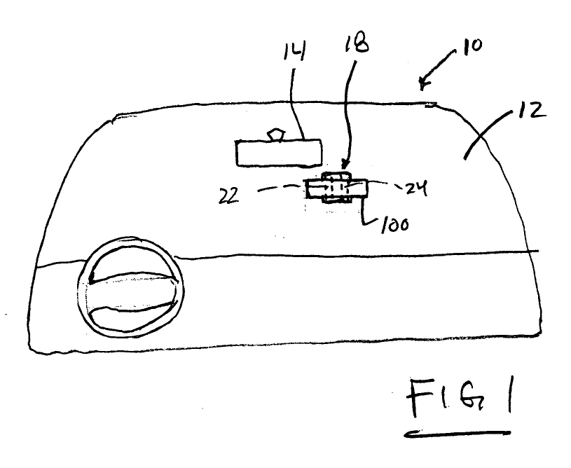

FIG. 1 illustrates in schematic form, a driver's view of an inside of a vehicle 10. The vehicle includes a windscreen or windshield 12 upon which is mounted a rear view mirror 14 and a toll transponder case 18 of the present invention. The toll transponder case is mounted to the windscreen 12 by two vertical fastener strips 22, 24, such as composed of hook and loop material which can include hooks, or loops, or a mixture of the two, or any other known configuration. As an alternate to the strips 22, 24, suction cups, magnetic material or any other known type of mounting a transponder to a windshield could be used. Preferably, the hook and loop strips 22, 24 are used and are adhesively secured to an inside of the windshield 12. Where “hook and loop” material is described herein, it should be understood that a strip having such material can include all hooks, or all loops or a mixture of hooks and loops, such as to be engageable with another such strip having all loops, or all hooks or a mixture of hooks and loops.

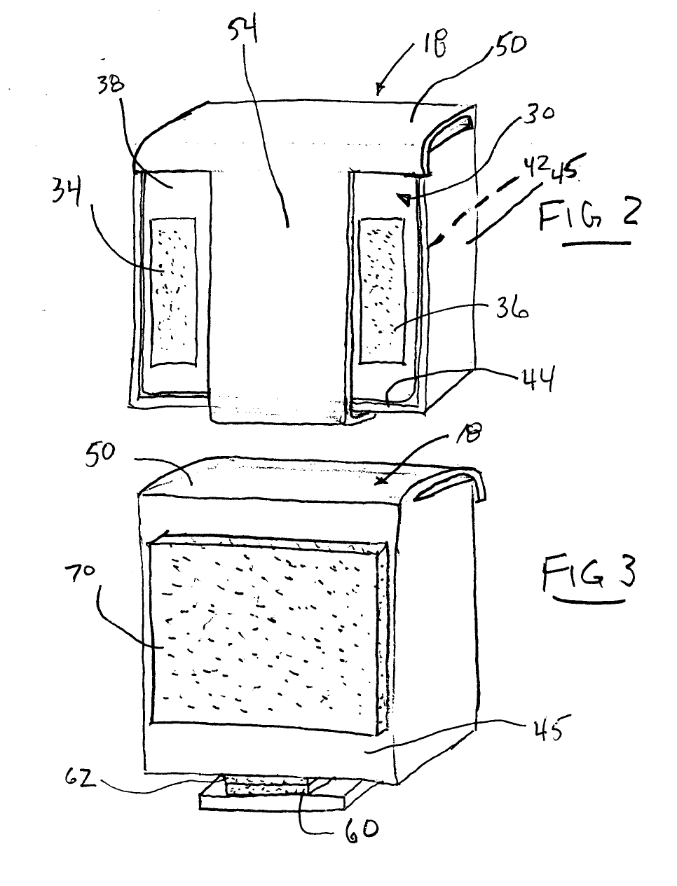

FIG. 2 illustrates a rear perspective view of the transponder case 18 of the invention. The foreground of this figure is the side of the case that will be held closest to the windshield 12 as installed. The case 18 holds a toll transponder 30 therein. The toll transponder 30 is a known device for receiving and sending toll signals on a highway for a highway authority to charge a fee to the motorist for use of the highway. The transponder 30 communicates with a station on the highway via a wireless signal. A typical transponder, for example as used in Illinois, USA, is referred to by the name “IPASS.”

The transponder 30 can include two strips 34, 36 of hook and loop material that engage with the strips 22, 24 secured to the windshield 12 to hold the transponder 30 and case 18 securely to the windshield 12. The strips 34, 36 are adhesively secured to a transponder housing 38.

The case 18 comprises a four sided, open box 42 or rectangular frame having an open face 44 for receiving the transponder 30. The open box 42 can be formed from a cardboard or plastic material and adds some shape rigidity to the case 18. A soft cover layer 45 is composed of a material, such as vinyl or leather, and covers a front open face 46 of the open box 42. The cover 45 can also be folded inward and secured over the bottom and sides of the open box to form soft inside surfaces 45a, 45b, 45c inside the open box 42. These soft surfaces 45a, 45b, 45c act to snugly contain the transponder 30 within the case 18. The cover 45 extends upwardly into a flap 50 that includes an elongated, narrow portion 54 that extends across the rear open face 44 and curls beneath the covered open box 42. The elongated portion 54 includes a hook and loop strip adhesively secured thereto which engages with a hook and loop strip 62 adhesively secured to the cover 45 on an underside of the open box 42. Thus the narrow portion 54 when extended across the open face 44 and secured by the strip 60, 62 retains the transponder 30 within the open box 42. The narrow portion 54 has a width and a thickness so as not interfere with the engagement of the hook and loop strips 34, 36 with the hook and loop strips 22, 24 mounted on the windshield 12.

Although the box or frame 42 is described above, it is not a required aspect of the invention in that it is possible that a material that forms the cover 45 holds its shape sufficiently without the need for the added reinforcement provided by the open box 42.

As an alternative to the case 18 as described up to this point, the case as described in U.S. Pat. No. 6,745,925 could be used as well, this patent herein incorporated by reference as modified by the present invention.

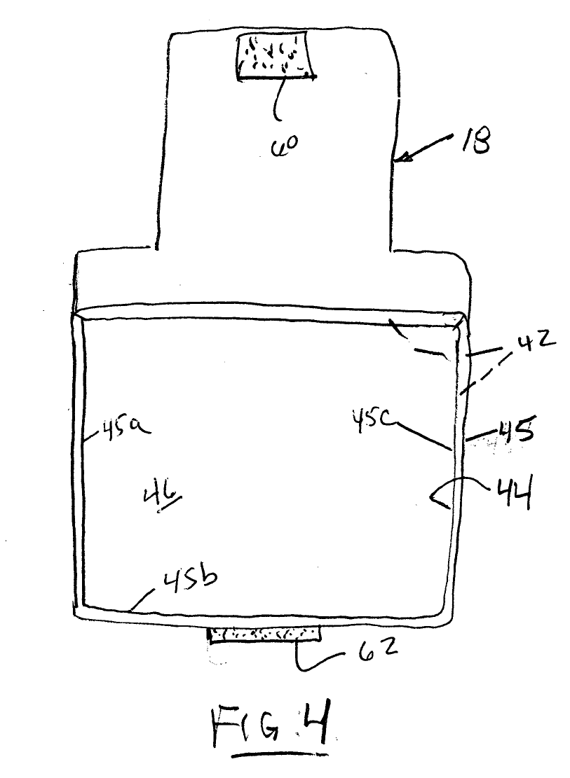

FIG. 3 illustrates that a front side of the case 18 includes an attachment panel 70 adhesively secured to the outer cover 45 of the case 18. This panel 70 is useful to attach functional items to the case 18. The panel 70 can be adhesively secured to the cover 45 or sewn to the cover 45, or attached by other known means. Preferably, the attachment panel is a wide strip of hook and loop material. However, other attachment methods are encompassed by the invention including clips, snap fasteners, magnetic material, etc.

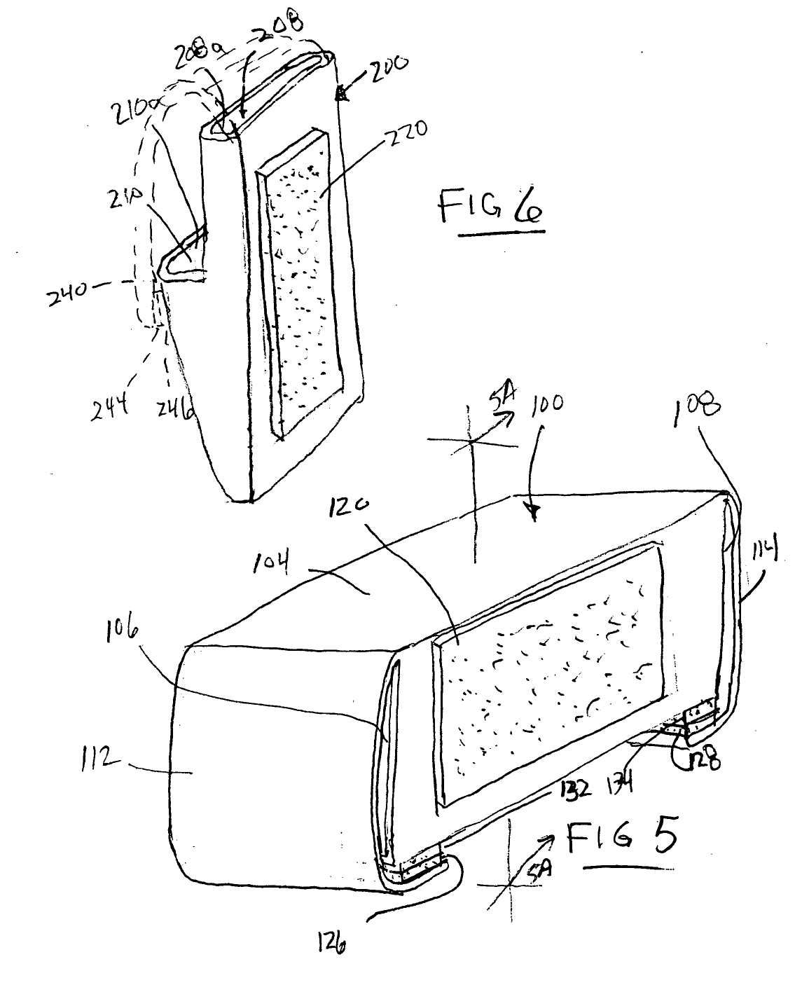

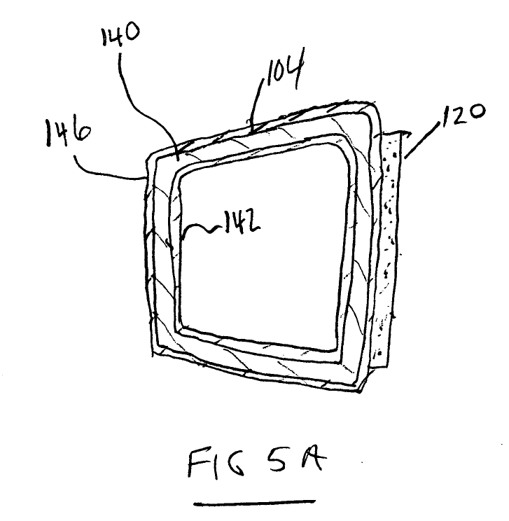

As an example of one such functional item, FIG. 5 illustrates an eyeglasses case 100 that includes a tubular body 104 having open ends 106, 108 and that are closed by flaps 112, 114. A hook and loop panel 120 is secured on a back side of the case 100, such as by adhesive or sewing. The panel 120 is engageable to the panel 70 shown in FIG. 3. Thus, the transponder 30 and case 18 can be releasably secured to the windshield via the strips 22, 24, 34, 36, and the eyeglasses case 100 can be held elevated on the case 18 as shown in FIG. 1. Thus, if the driver or passenger needs eyeglasses or sunglasses either one of the flaps 112, 114 can be opened to retrieve the eyeglasses or sunglasses. In this regard, the flaps 112, 114 include hook and loop strips 126, 128 secured to ends of the flaps 112, 114. They tubular body 104 includes hook and loop strips 132, 134 that are engaged by the adhesive strips 126, 128 to hold the flaps closed. Because the attachment of the eyeglasses case is releasable, the eyeglasses case can be removed from the vehicle as desired with or without the case 18.

FIG. 5A illustrates, in a diagrammatic fashion, one construction of the tubular body 104. The body 104 includes a tubular support 140, such as composed of cardboard or plastic. A soft inner lining 142 such as felt, or the like, is applied onto an inside surface of the support 140. A cover layer 146 covers the support 140 and also extends continuously into the flaps 112 114. The cover layer 146 can be vinyl or leather and preferably matches the cover 45 of the case 18.

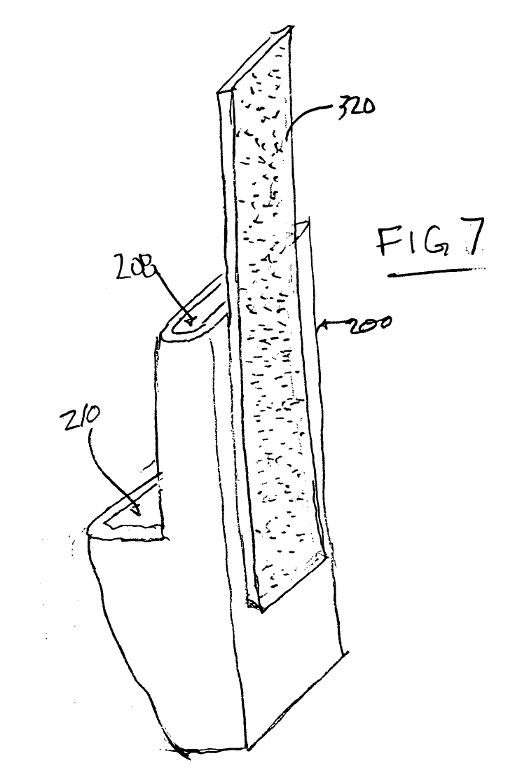

FIG. 6 illustrates an alternate functional attachment, a pocket 200. The pocket 200 can include two compartments, a tall compartment 208, and a short compartment 210. The tall compartment 208 is useful for holding pencils, pens, and other tall items. The short compartment 210 can be useful for holding receipts, small change or other small items. The tall or short pocket could be sized to hold a cellular telephone. The pocket 200 can be sewn together from a vinyl or leather stock material preferably that matches the vinyl or leather material of the cover 45 of the case 18. A hook and loop strip 220 can be adhesively secured or sewn to a back side of the pocket 200. This strip 220 is engageable to the strip 70 of the case 18. Thus, the pocket 200 can be held elevated on the case 18 as it is secured to the windshield 12.

The pocket 200 can also be provided with one or more flaps 240 (shown dashed) to close the open ends 208a, 210a of the compartments. A hook and loop strip 244 is secured to the flap 240 that engages a hook and loop strip 246 secured to a front portion of the pocket 200 to hold the flap 240 in closed condition. Thus, the pocket 200 can be removed from the case 18, or with the case 18, and items can be held secured in the pocket as the case 18 is moved within or outside the vehicle.

FIG. 7 illustrates an alternate embodiment of the pocket shown in figure six wherein the strip 220 shown in FIG. 6 is elongated to an extent above the compartments 208, 210 forming a strip 320. The strip 320 can function as a hanger to hang the pocket 200 down to a position below the case 18 as installed on the windshield 12. This strip 320 gives more flexibility of attachment of the pocket 200 depending on the configuration of the windshield and object interferences within the particular vehicle. The elongated strip 320 can also be used with the eyeglasses case 100 to provide more flexibility of elevational location of the eyeglasses case 100 with respect to the case 18. The strip 320 can be adhesively secured or sewn to a backside of the pocket 200, or if used with the eyeglasses case 100, to the tubular body 14.

Although an eyeglasses case and a pocket are described, the invention would also be useful for holders for flashlights, map holders, or other useful items.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A toll transponder case assembly, comprising:
a transponder case for surrounding at least a portion of a toll transponder;
a holder for holding items, wherein said transponder case and said holder are interengageable by the use of a releasable fastener.

2. The assembly according to claim 1, wherein said releasable fastener comprises interengaging hook and loop strips applied between said case and said holder.

3. The assembly according to claim 1, wherein said holder comprises an eyeglasses case.

4. The assembly according to claim 3, wherein said eyeglasses case includes a closable opening on each opposite end of said eyeglasses case.

5. The assembly according to claim 4, wherein said eyeglasses case comprises a tubular body closed on opposite ends by an openable flap.

6. The assembly according to claim 1 wherein said holder comprises a pocket.

7. The assembly according to claim 6, wherein said pocket is closed by at least one flap to secure items therein.

8. The assembly according to claim 1, wherein said releasable fastener comprises engageable fastening strips, applied to both said transponder case and to said holder, wherein said fastening strip applied to said holder extends above said holder.

9. The assembly according to claim 1, wherein said releasable fastener comprises a fastening strip applied onto a front side of said transponder case and a fastening strip applied onto a rear side of said holder wherein a back side or said holder is releasably fastened to a front side of said transponder case.
